(19) United States
(12) Patent Application Publication
(10) Pub. No.: US 2023/0250931 A1
(43) Pub. Date: Aug. 10, 2023

(54) LED RETROFIT LAMP FOR AN AUTOMOTIVE LIGHTING SYSTEM AND METHOD OF MANUFACTURE

(71) Applicant: LUMILEDS LLC, San Jose, CA (US)

(72) Inventor: Juergen Mertens, Wuerselen (DE)

(73) Assignee: LUMILEDS LLC, San Jose, CA (US)

(21) Appl. No.: 18/014,694

(22) PCT Filed: Jul. 6, 2021
(86) PCT No.: PCT/US2021/040502

§ 371 Date: Jan. 5, 2023

Related U.S. Application Data
(60) Provisional application No. 63/048,594, filed on Jul. 6, 2020.

(30) Foreign Application Priority Data
Aug. 6, 2020 (EP) 20189759.2

(51) Int. Cl. F21S 41/19; F21S 41/148; F21S 45/47

(52) U.S. Cl. CPC F21S 41/192; F21S 41/148; F21S 45/47

(57) ABSTRACT

A light-emitting diode (LED) retrofit lamp includes a lamp body, an LED light source, an attachment ring and at least one fixing element. The lamp body has at least one opening. The elastic element is coupled to the lamp body at a first end. The LED light source is coupled to the lamp body at a second end opposite the first end. The attachment ring includes a first wavelike axial end face and a second axial end face opposite the first wavelike axial end face. The first wavelike axial end face includes a plurality of wave troughs and wave crests. The second axial end face abuts the elastic element. The at least one fixing element is disposed through at least one of the at least one opening in the lamp body and at least one of the wave troughs of the first wavelike axial end face of the attachment ring.

### CROSS REFERENCE TO RELATED APPLICATIONS

This application claims the benefit of U.S. Provisional Patent Application No. 63/048,594, which was filed on Jul. 6, 2020, and European Patent Application No. 20189759.2, which was filed on Aug. 6, 2020, the contents of which are hereby incorporated by reference herein.

### BACKGROUND

Light emitting diodes (LEDs) are rapidly gaining popularity because of their longevity and low energy credentials. Advances in manufacturing have led to the emergence of chip-sized LED packages or modules in which at least one LED, and often a plurality of LEDs, are packaged together, for example in a matrix-like manner comprising multiple rows of LEDs. Application domains for such LED modules may include, but are not limited to, automotive front lighting, such as vehicle headlamps.

### SUMMARY

A light-emitting diode (LED) retrofit lamp includes a lamp body, an LED light source, an attachment ring and at least one fixing element. The lamp body has at least one opening therein. The elastic element is coupled to the lamp body at a first end. The LED light source is coupled to the lamp body at a second end opposite the first end. The attachment ring includes a first wavelike axial end face and a second axial end face opposite the first wavelike axial end face. The first wavelike axial end face includes a plurality of wave troughs and a plurality of wave crests. The second axial end face abuts the elastic element. The at least one fixing element is disposed through at least one of the at least one opening in the lamp body and at least one of the wave troughs of the first wavelike axial end face of the attachment ring.

### BRIEF DESCRIPTION OF THE DRAWINGS

A more detailed understanding can be had from the following description, given by way of example in conjunction with the accompanying drawings wherein:

FIG. 1 is a perspective side view of an example LED retrofit lamp;

FIG. 2 is a side view of the example LED retrofit lamp of FIG. 1;

FIG. 3 is an enlarged partial side view of a portion of the LED retrofit lamp encircled in FIG. 2;

FIG. 4 is an enlarged partial side view of another example LED retrofit lamp;

FIG. 5 is a first enlarged partial perspective sectional view (A) of the LED retrofit lamp of FIG. 1 illustrating a first operational state and a second enlarged partial perspective sectional view (B) of the LED retrofit lamp of FIG. 1 illustrating a second operational state;

FIG. 6 is a flow diagram of a method of assembling an LED retrofit lamp;

FIG. 7 is a diagram of an example vehicle headlamp system; and

FIG. 8 is a diagram of another example vehicle headlamp system.

### DETAILED DESCRIPTION

Examples of different light illumination systems and/or light emitting diode (“LED”) implementations will be described more fully hereinafter with reference to the accompanying drawings. These examples are not mutually exclusive, and features found in one example may be combined with features found in one or more other examples to achieve additional implementations. Accordingly, it will be understood that the examples shown in the accompanying drawings are provided for illustrative purposes only and they are not intended to limit the disclosure in any way. Like numbers refer to like elements throughout.

It will be understood that, although the terms first, second, third, etc. may be used herein to describe various elements, these elements should not be limited by these terms. These terms may be used to distinguish one element from another. For example, a first element may be termed a second element and a second element may be termed a first element without departing from the scope of the present invention. As used herein, the term “and/or” may include any and all combinations of one or more of the associated listed items.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there may be no intervening elements present. It will also be understood that when an element is referred to as being “connected” or “coupled” to another element, it may be directly connected or coupled to the other element and/or connected or coupled to the other element via one or more intervening elements. In contrast, when an element is referred to as being “directly connected” or “directly coupled” to another element, there are no intervening elements present between the element and the other element. It will be understood that these terms are intended to encompass different orientations of the element in addition to any orientation depicted in the figures.

Relative terms such as “below,” “above,” “upper,”, “lower,” “horizontal” or “vertical” may be used herein to describe a relationship of one element, layer, or region to another element, layer, or region as illustrated in the figures. It will be understood that these terms are intended to encompass different orientations of the device in addition to the orientation depicted in the figures.

While LEDs are becoming more popular, many conventional incandescent type lamps or light bulbs (e.g., halogen lamps) are still used, for example as vehicle headlamps. The angular light emission of a conventional incandescent type lamp is close to 360 degrees, and conventional luminaires are designed to use most of the generated light in an efficient way. Given this, it may be desirable to replace a conventional lamp, such as a halogen bulb lamp of a vehicle headlamp, with an LED retrofit lamp without having to replace the original lamp fixture or socket or even the entire lamp housing and lamp entity, respectively. Consequently, the LED retrofit lamp may use the same lamp mount or fixture of the incandescent type lamp, thus facilitating cost-efficient, easy installation and short set-up times.

However, the light emission angle range of an LED retrofit lamp may be limited due to the directional light emission characteristic of the LED light source or LED package, respectively. Proper rotational positioning of the LED retrofit may therefore be required to improve the light beam performance or comply with appropriate regulations.

Accordingly, there may be a need for an LED retrofit lamp that has an improved performance, where performance may be assessed, inter alia, on the qualities of illumination performance, installation ease, set-up time, and manufacturing ease and cost. Embodiments described provide for an LED retrofit lamp, such as for use in a vehicle headlamp, that may provide high illumination performance, improved installation ease and set-up time, and improved manufacturing ease and cost.

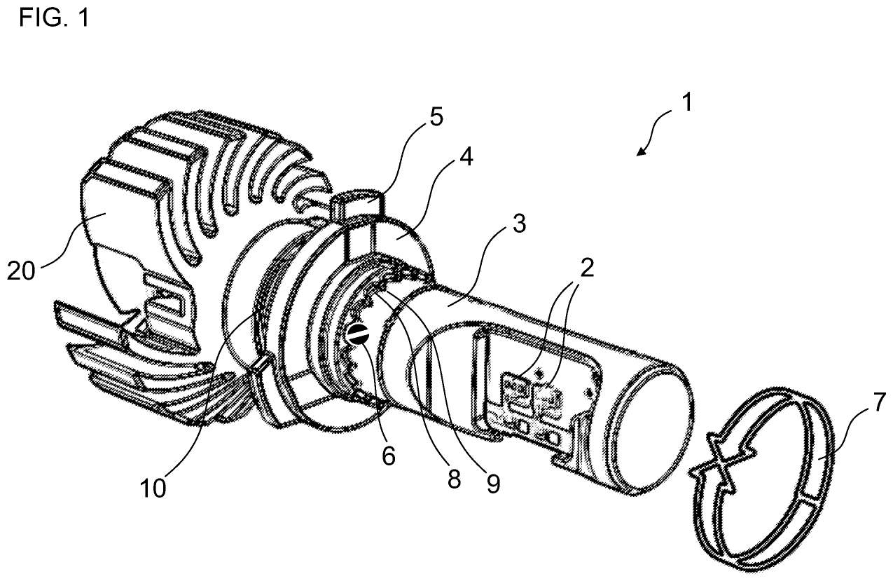

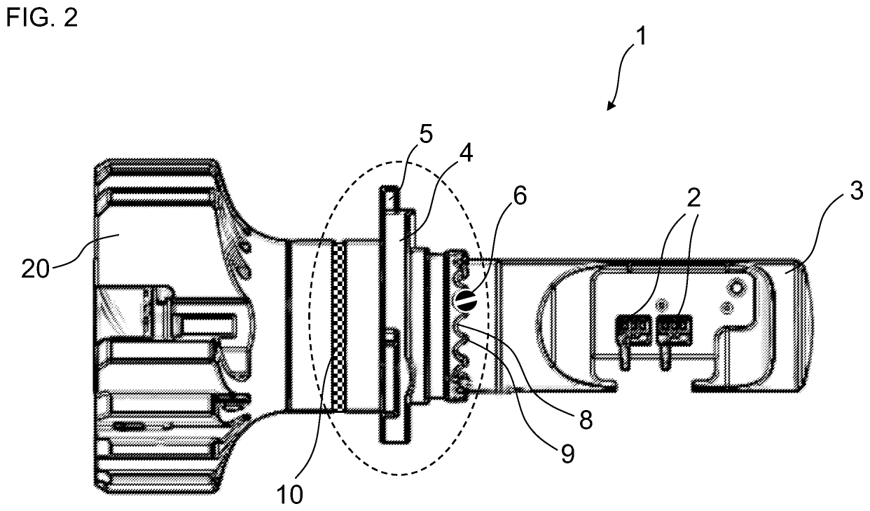

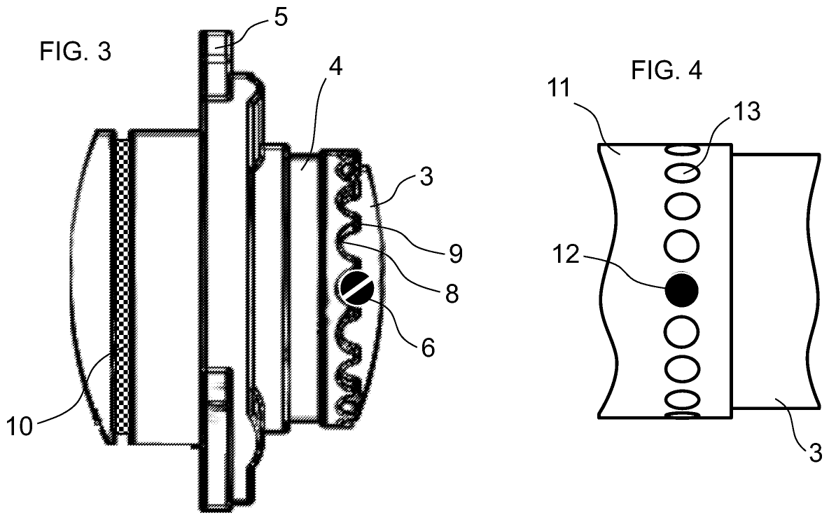

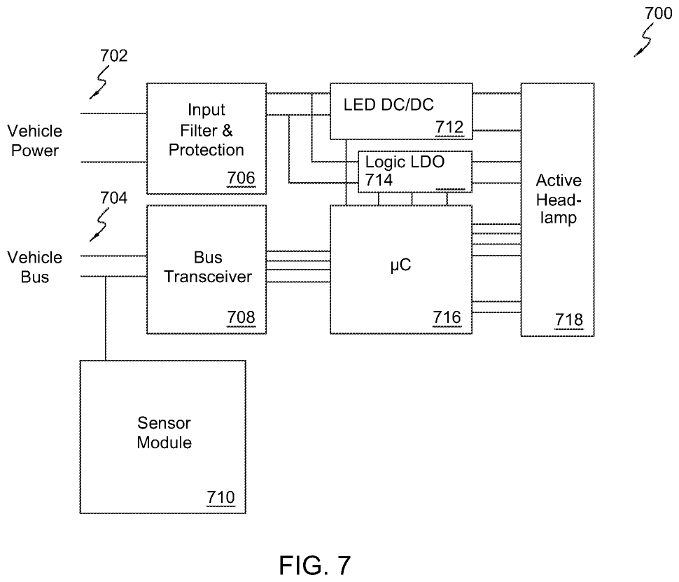

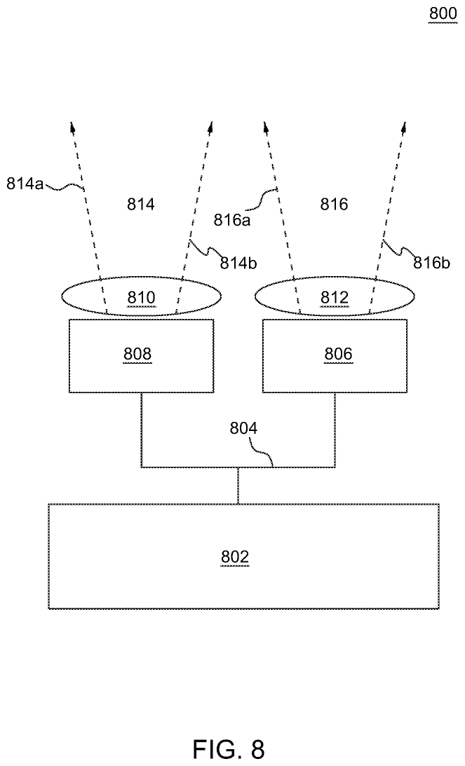

FIG. 1 is a perspective side view of an example LED retrofit lamp 1. FIG. 2 is a side view of the example LED retrofit lamp of FIG. 1. FIG. 3 is an enlarged partial side view of a portion of the LED retrofit lamp 1 encircled in FIG. 2. The LED retrofit lamp 1 illustrated in FIGS. 1,2, and 3 may serve as a replacement lamp for a conventional incandescent type lamp, such as a halogen bulb lamp, of a vehicle headlamp (illustrated in the block diagrams in FIGS. 7 and 8). Although the use of the LED retrofit lamp according to embodiments described herein may be used as a replacement lamp for vehicle headlamps, this is just an example, and other application domains may be conceivable as well.

The example LED retrofit lamp 1 shown in FIGS. 1 and 2 comprises an LED light source 2, a lamp body 3 and an attachment ring 4. In the example illustrated in FIGS. 1 and 2, the LED light source 2 includes two separate LED light modules comprising a plurality of individual LEDs each. However, the embodiments described herein are not limited to the specific number and/or arrangement of individual LEDs or LED packages/modules illustrated in FIGS. 1 and 2. The LED light source 2 (e.g., the LEDs or LED packages) may be mounted to the lamp body 3. The attachment ring 4 may be engageable with, and rotatable relative to, the lamp body 3. The attachment ring 4 may be configured so as to be attachable to a lamp holder (not shown). The attachment ring 4 of the example LED retrofit lamp 1 may include a bayonet coupling 5 for attachment to the lamp holder, without being limited to bayonet catches. The bayonet coupling may allow installation of the LED retrofit lamp by a simple, linear insertion movement followed by a rotational movement and vice versa.

The example LED retrofit lamp 1 illustrated in FIGS. 1, 2, and 3 also includes at least one fixing element 6 detachably engageable with both the lamp body 3 and the attachment ring 4 so as to, in its engaged state, securely fix the attachment ring 4 in one of a plurality of predetermined angular positions relative to the lamp body 3. The rotational movability of the attachment ring 4 relative to the lamp body 3 is indicated by an arrow 7 in FIG. 1.

In the example illustrated in FIGS. 1, 2, and 3, two such fixing element 6 are provided, only one of which is visible in FIGS. 1, 2, and 3. However, only one single fixing element 6 may be present or more than two fixing elements 6 (e.g., three, four, five or six fixing elements) may be provided to engage the attachment ring 4 when fixed to the lamp body 3.

In the embodiment illustrated in FIGS. 1, 2, and 3, the fixing element(s) 6 are screws, which may be threadable into respective screw holes formed in the lamp body 3. In the illustrated example, for each screw 6 there may also be provided only one single respective screw hole formed in the lamp body 3 of the LED retrofit lamp 1. If more than one screw hole is provided on the lamp body 3, the screw holes may be distributed circumferentially on the lamp body 3, such as equidistantly (although not being limited thereto). It should also be understood that more screw holes than the number of fixing element(s) 6 may be provided on the lamp body, thus facilitating even more fine-grained angular adjustments of the attachment ring 4 relative to the lamp body 3 as will become more apparent further below. Use of screws as the fixing element(s) may allow non-destructive and hassle-free detachment of the fixing element and reattaching thereof in a way that is fast and comfortable to carry out.

From FIG. 1, it is observable that the angular position of the attachment ring 4 relative to the lamp body 3 may be fixed by the fixing element 6 through form-locking. In the example illustrated FIGS. 1, 2, and 3, the attachment ring 4 of the LED retrofit lamp 1 has a wavelike axial end face having a plurality of wave troughs 8 and wave crests 9. The fixing element 6, such as the screw or screws 6 in the illustrated example, when being engaged with the lamp body 3, may also engage with one of the wave troughs 8 of the attachment ring 3. This form-locked join between the fixing element 6 fixed to the lamp body 3 and the wave trough 8 of the attachment ring 4 may ensure a rigid and robust connection that withstands torque forces required to operationally engage the bayonet coupling 5 with a bayonet catch of the lamp holder (both not shown). The total number of wave troughs 8 separated from each other by the wave crests 9 as well as the specific distance between adjacent wave troughs 8 and wave crests 9, respectively, may determine the specific number and precise angles the attachment ring 4 may be positioned relative to the lamp body 3.

It is to be noted that all wave troughs 8 provided on the axial end face of the attachment ring 4 may be distributed equidistantly to enable angular adjustments of the attachment ring 4 relative to the lamp body 3 with evenly distributed angular distances. However, it may be conceived to distribute the wave troughs 8 irregularly along the axial end face of the attachment ring, thus enabling specific fine-grained angular adjustments only within a predetermined angular range while excluding other angular ranges, for example. In this way, appropriate regulations may be complied with accurately and/or the illumination performance of the LED retrofit lamp may be optimized and/or assembly faults may be prevented, for example.

Further, in the example illustrated in FIGS. 1, 2, and 3, the attachment ring 4 is biased against the fixing element 6 by means of an elastic element 10 (illustrated as an elastic O-ring in FIGS. 1, 2, and 3, though not being limited thereto). The O-ring may facilitate easy installation, cost-effective manufacturing of the LED retrofit lamp and sealing the part of the lamp inserted in the headlamp module from the environment. Other elastic elements may be envisaged such as springs made from metal or plastic material, coil springs, disc springs, spring washers, elastic clips and/or clamps, rubber elements, and the like. This may improve torque proof coupling of the attachment ring and the lamp body by the fixing element. Further, potential axial play between the attachment ring and the lamp body may be efficiently eliminated, thus preventing rattling and/or detrimental wear between moving parts.

The elastic element 10 may force the attachment ring 4 against the fixing element 6 when fixed to the lamp body 3, thus further improving the form-locking coupling between the respective wave trough 8 and the fixing element 6. Additionally, potential (axial) play between the lamp body 3 and the attachment ring 4 may be eliminated. In this way, the relative angular position of the attachment ring with respect to the lamp body and, consequently, also the relative angular position of the LED light source with respect to the lamp holder when being mounted thereon may securely be maintained during the installation of the retrofit lamp, particularly if the installation requires exerting a rotational movement of the LED retrofit lamp to achieve proper fixation thereof to the lamp holder. The form-locking engagement of the fixing means may be configured to withstand such torsional forces during installation processes.

As may be further observable from FIGS. 1, 2, and 3, the O-ring 10 may be fixedly arranged on the lamp body 3 and may abut against a second axial end surface of the attachment ring 4 (the axial end surface opposite the axial end face of the attachment ring 3 that has the wave troughs 8 and wave crests 9 formed thereon). The elastic element 10 may be sandwiched between a heat sink 20 of the LED retrofit lamp 1 and the attachment ring 4, though not being limited to such a configuration.

FIG. 4 is an enlarged partial side view of another example LED retrofit lamp. The LED retrofit lamp illustrated in FIG. 4 may correspond essentially with the configuration of the LED retrofit lamp 1 shown in FIG. 1 except for the attachment ring 11 and the fixing element 12.

In the example illustrated in FIG. 4, the fixing element 12 is a pin, which may be securely pluggable into the lamp body 3. Further, the attachment ring 11 of the LED retrofit lamp shown in FIG. 4 may include a plurality of circumferentially distributed through holes 13. The pin 12, when engaged with the lamp body 3, may pass through one of the through holes 13 of the attachment ring 11 forming the form-locked join as described herein. Similar to the embodiment illustrated in FIGS. 1, 2, and 3, one, two or more pins 12 may be provided to securely fix the attachment ring 11 in a predetermined angular position relative to the lamp body 3. Using such an embodiment, rather than screwing the fixing element, it may be clamped and/or locked with the lamp body, thus also allowing non-destructive detachment of the fixing element and reattaching thereof in the shortest time in a straightforward manner. In embodiments, the through holes may be manufactured by cost-effective machining, drilling, casting, or the like, while facilitating a robust form-locked join.

The circumferential distribution of the through holes 13 on the attachment ring 11 may be as described above with respect to the circumferential distribution of the wave troughs 8 on the attachment ring 4 of the LED retrofit lamp 1 of FIGS. 1, 2, and 3. Further, it is to be noted that the combination of through holes 13 on the attachment ring 11 and the pin 12 as the fixing element shown in FIG. 4 is not an obligatory combination. Rather, according to yet other embodiments (not shown), the attachment ring may comprise the wave troughs 8 and wave crests 9 shown in the embodiment of the LED retrofit lamp 1 of FIGS. 1-3 while having the pin 12 as the fixing element instead of the screw 6 of the LED retrofit lamp 1 illustrated in FIGS. 1, 2, and 3. It is to be understood that the pin 12 may engage with one of the wave troughs 8 to fix the attachment ring in a predetermined desired angular position relative to the lamp body in this case.

In still other embodiments (also not shown), the attachment ring may comprise the through holes 13 of the embodiment of the LED retrofit lamp shown in FIG. 4 while having the screw 6 of the embodiment of the LED retrofit lamp 1 as the fixing element instead of the pin 12 shown in FIG. 4. In this case, the screw may pass through one of the plurality of through holes 13 provided on the attachment ring to properly fix the attachment ring at one of multiple predetermined angular positions relative to the lamp body.

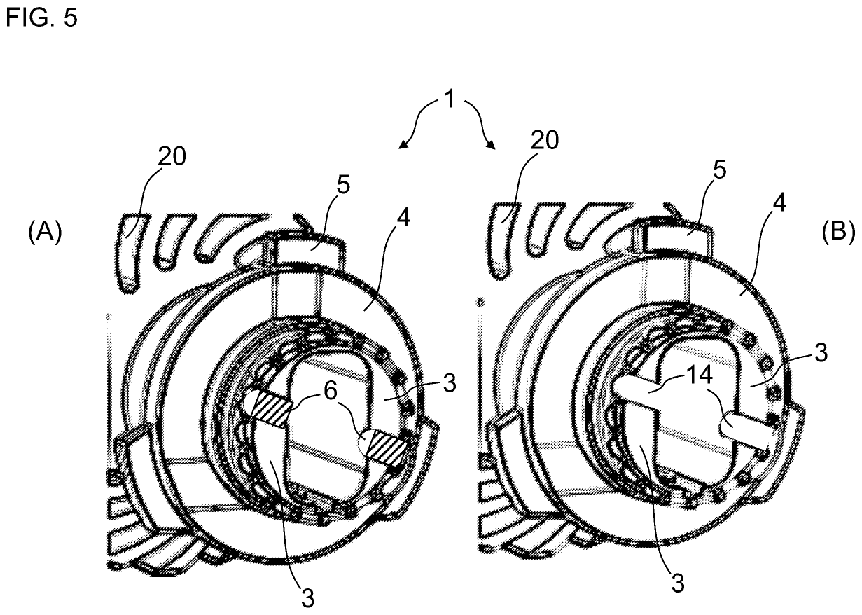

FIG. 5 is a first enlarged partial perspective sectional view (A) of the LED retrofit lamp 1 of FIG. 1 illustrating a first operational state and a second enlarged partial perspective sectional view (B) of the LED retrofit lamp 1 of FIG. 1 illustrating a second operational state.

In the first operational state (A), the fixing element 6 (e.g., the screws 6 in the illustrated embodiment) may be fixed in respective screw holes 14 of the lamp body 3 while engaging a respective wave trough 8 of the attachment ring 4. In this state, the attachment ring 4 may be rotationally fixed relative to the lamp body 3 in a selected angular position.

In the operational state (B), the screws 6 may be removed from the respective screw holes 14, thus facilitating free rotational movement of the attachment ring 4 relative to the lamp body 3. In this way, a new angular position of the attachment ring 4 relative to the lamp body 3 may be selected corresponding to the available wave troughs 8 on the axial end face of the attachment ring 4.

In embodiments, the attachment ring may be formed from a material comprising one of Polyphenylene Sulfide (PPS), Polyvinyl Toluene (PVT), Polyamide 6,6 (PA66), Polyamide 4,6 (PA46), Liquid Crystal Polymer (LCP), Polyether Ether Ketone (PEEK), Polyphthalamide (PPA), a resin grade, or any combination thereof. The attachment ring may be manufactured using, for example, injection molding. Alternatively, or additionally, the attachment ring may be manufactured from a material comprising at least one of glass fibers and carbon fibers imparting additional rigidity and robustness to the attachment ring. Use of such materials and manufacturing processes may provide for improved manufacturing ease and reduced cost, such as by use of injection molding processed for manufacturing an O-ring, for example.

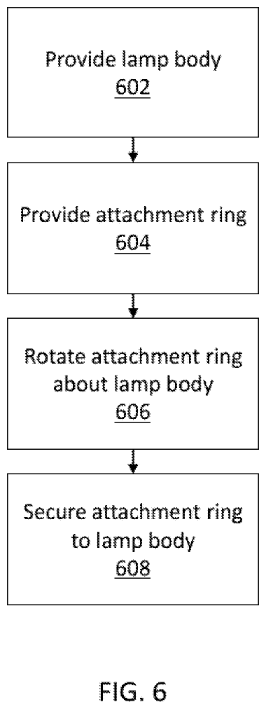

FIG. 6 is a flow diagram of a method of assembling a light-emitting diode (LED) retrofit lamp. In the example illustrated in FIG. 6, the method includes providing a lamp body (602). In embodiments, the lamp body may include, for example, at least one opening, an elastic element coupled to the lamp body at a first end, and an LED light source coupled to the lamp body at a second end opposite the first end. The method may also include providing an attachment ring (604). In embodiments, the attachment ring may include, for example, a first wavelike axial end face and a second axial end face opposite the first wavelike axial end face. The first wavelike axial end face may include a plurality of wave troughs and a plurality of wave crests, and the second axial end face may abut the elastic element.

The attachment ring may be rotated about the lamp body (606). In embodiments, the attachment ring may be rotated about the lamp body until the attachment ring is at a desired angular position relative to the lamp body. The attachment ring may be secured to the lamp body (608). The attachment ring may be secured to the lamp body at least in part by inserting a fixing element through the opening in the fixing element and engaging with one of the plurality of wave troughs.

In embodiments, the wavelike end face may be manufactured, for example, by machining, casting, or the like, thus improving manufacturing ease and cost while facilitation a robust form-locked join.

As mentioned above, embodiments of the LED retrofit lamp described herein may be used, for example, in automotive lighting systems. In such systems, for example, the LED retrofit lamp may be attached to a lamp holder, such as a lamp fixture or a lamp mount of a vehicle headlamp, by means of the attachment ring. During times when the fixing element is detached from the lamp body, the attachment ring may be rotated relative to the lamp body. With the fixing element attached to the lamp body, it may engage the attachment ring such that the attachment ring may be securely fixed in one of several predetermined angular positions relative to the lamp body.

Since the attachment ring is attachable to the lamp holder, for example, it may also provide an attaching element for attachment to the lamp holder. Consequently, it may guarantee a predetermined angular position of the LED light source relative to the lamp holder as well when the LED retrofit lamp is installed in the lamp holder. Thus, an appropriate light emission direction of the LED light source of the LED retrofit lamp with respect to an optimal illumination performance can always be ensured with any lamp holder. Therefore, the LED retrofit lamp according to the embodiments described herein may be adapted easily to a specific lamp holder to always yield a maximum/optimal illumination performance and/or compliance with respective regulations when mounted to a given lamp holder.

Furthermore, setting up the attachment ring relative to the lamp body of the LED retrofit lamp may be achieved in shortest time by simply detaching the fixing means, rotating the attachment ring into its desired angular position, and finally engaging the fixing means with both the lamp body and the attachment ring again, thus further improving ease of use.

FIG. 7 is a diagram of an example vehicle headlamp system 700 that may incorporate one or more of the embodiments and examples described herein. The example vehicle headlamp system 700 illustrated in FIG. 7 may include power lines 702, a data bus 704, an input filter and protection module 706, a bus transceiver 708, a sensor module 710, an LED direct current to direct current (DC/DC) module 712, a logic low-dropout (LDO) module 714, a micro-controller 716 and an active head lamp 718.

The power lines 702 may have inputs that receive power from a vehicle, and the data bus 704 may have inputs/outputs over which data may be exchanged between the vehicle and the vehicle headlamp system 700. For example, the vehicle headlamp system 700 may receive instructions from other locations in the vehicle, such as instructions to turn on turn signaling or turn on headlamps, and may send feedback to other locations in the vehicle if desired. The sensor module 710 may be communicatively coupled to the data bus 704 and may provide additional data to the vehicle headlamp system 700 or other locations in the vehicle related to, for example, environmental conditions (e.g., time of day, rain, fog, or ambient light levels), vehicle state (e.g., parked, in-motion, speed of motion, or direction of motion), and presence/position of other objects (e.g., vehicles or pedestrians). A headlamp controller that is separate from any vehicle controller communicatively coupled to the vehicle data bus may also be included in the vehicle headlamp system 700. In FIG. 7, the headlamp controller may be a micro-controller, such as micro-controller (μc) 716. The micro-controller 716 may be communicatively coupled to the data bus 704.

The input filter and protection module 706 may be electrically coupled to the power lines 702 and may, for example, support various filters to reduce conducted emissions and provide power immunity. Additionally, the input filter and protection module 106 may provide electrostatic discharge (ESD) protection, load-dump protection, alternator field decay protection, and/or reverse polarity protection.

The LED DC/DC module 712 may be coupled between the input filter and protection module 706 and the active headlamp 718 to receive filtered power and provide a drive current to power LEDs in the LED array in the active headlamp 718. The LED DC/DC module 712 may have an input voltage between 7 and 18 volts with a nominal voltage of approximately 13.2 volts and an output voltage that may be slightly higher (e.g., 0.3 volts) than a maximum voltage for the LED array (e.g., as determined by factor or local calibration and operating condition adjustments due to load, temperature or other factors).

The logic LDO module 714 may be coupled to the input filter and protection module 706 to receive the filtered power. The logic LDO module 714 may also be coupled to the micro-controller 716 and the active headlamp 718 to provide power to the micro-controller 716 and/or electronics in the active headlamp 718, such as CMOS logic.

The bus transceiver 708 may have, for example, a universal asynchronous receiver transmitter (UART) or serial peripheral interface (SPI) interface and may be coupled to the micro-controller 716. The micro-controller 716 may translate vehicle input based on, or including, data from the sensor module 710. The translated vehicle input may include a video signal that is transferrable to an image buffer in the active headlamp 718. In addition, the micro-controller 716 may load default image frames and test for open/short pixels during startup. In embodiments, an SPI interface may load an image buffer in CMOS. Image frames may be full frame, differential or partial frames. Other features of micro-controller 716 may include control interface monitoring of CMOS status, including die temperature, as well as logic LDO output. In embodiments, LED DC/DC output may be dynamically controlled to minimize headroom. In addition to providing image frame data, other headlamp functions, such as complementary use in conjunction with side marker or turn signal lights, and/or activation of daytime running lights, may also be controlled.

FIG. 8 is a diagram of another example vehicle headlamp system 800. The example vehicle headlamp system 800 illustrated in FIG. 8 includes an application platform 802, two LED lighting systems 806 and 808, and secondary optics 810 and 812.

The LED lighting system 808 may emit light beams 814 (shown between arrows 814a and 814b in FIG. 8). The LED lighting system 806 may emit light beams 816 (shown between arrows 816a and 816b in FIG. 8). In the embodiment shown in FIG. 8, a secondary optic 810 is adjacent the LED lighting system 808, and the light emitted from the LED lighting system 808 passes through the secondary optic 810. Similarly, a secondary optic 812 is adjacent the LED lighting system 806, and the light emitted from the LED lighting system 806 passes through the secondary optic 812. In alternative embodiments, no secondary optics 810/812 are provided in the vehicle headlamp system.

Where included, the secondary optics 810/812 may be or include one or more light guides. The one or more light guides may be edge lit or may have an interior opening that defines an interior edge of the light guide. LED lighting systems 808 and 806 may be inserted in the interior openings of the one or more light guides such that they inject light into the interior edge (interior opening light guide) or exterior edge (edge lit light guide) of the one or more light guides. In embodiments, the one or more light guides may shape the light emitted by the LED lighting systems 808 and 806 in a desired manner, such as, for example, with a gradient, a chamfered distribution, a narrow distribution, a wide distribution, or an angular distribution.

The application platform 802 may provide power and/or data to the LED lighting systems 806 and/or 808 via lines 804, which may include one or more or a portion of the power lines 702 and the data bus 704 of FIG. 7. One or more sensors (which may be the sensors in the vehicle headlamp system 800 or other additional sensors) may be internal or external to the housing of the application platform 802. Alternatively, or in addition, as shown in the example vehicle headlamp system 700 of FIG. 7, each LED lighting system 808 and 806 may include its own sensor module, connectivity and control module, power module, and/or LED array.

In embodiments, the vehicle headlamp system 800 may represent an automobile with steerable light beams where LEDs may be selectively activated to provide steerable light. For example, an array of LEDs or emitters may be used to define or project a shape or pattern or illuminate only selected sections of a roadway. In an example embodiment, infrared cameras or detector pixels within LED lighting systems 806 and 808 may be sensors (e.g., similar to sensors in the sensor module 710 of FIG. 7 that identify portions of a scene (e.g., roadway or pedestrian crossing) that require illumination.

Having described the embodiments in detail, those skilled in the art will appreciate that, given the present description, modifications may be made to the embodiments described herein without departing from the spirit of the inventive concept. Therefore, it is not intended that the scope of the invention be limited to the specific embodiments illustrated and described.

1. A light-emitting diode (LED) retrofit lamp comprising:
a lamp body having at least one opening therein;
an elastic element coupled to the lamp body at a first end;
an LED light source coupled to the lamp body at a second end opposite the first end;
an attachment ring comprising a first wavelike axial end face and a second axial end face opposite the first wavelike axial end face, the first wavelike axial end face comprising a plurality of wave troughs and a plurality of wave crests, and the second axial end face abutting the elastic element; and
at least one fixing element disposed through at least one of the at least one opening in the lamp body and at least one of the wave troughs of the first wavelike axial end face of the attachment ring.

2. The LED retrofit lamp as claimed in claim 1, wherein the at least one fixing element is detachably engageable with both the lamp body and the attachment ring via the at least one of the at least one opening in the lamp body and the at least one of the wave troughs of the first wavelike axial end face of the attachment ring such as to, in its engaged state, securely fix the attachment ring in one of a plurality of predetermined angular positions relative to the lamp body.

3. The LED retrofit lamp as claimed in claim 2, wherein the angular position of the attachment ring relative to the lamp body is fixed by the fixing element through form-locking.

4. The LED retrofit lamp as claimed in claim 1, wherein the fixing element is a screw.

5. The LED retrofit lamp as claimed in claim 1, wherein the fixing element is a pin.

6. The LED retrofit lamp as claimed in claim 1, wherein the fixing element, when engaged with the lamp body, also engages with the one of the wave troughs of the attachment ring.

7. The LED retrofit lamp as claimed in claim 1, wherein the attachment ring is biased against the fixing element, when being engaged with the lamp body, by means of the elastic element.

8. The LED retrofit lamp as claimed in claim 1, wherein the elastic element is an O-ring.

9. The LED retrofit lamp as claimed in claim 1, wherein the attachment ring comprises a bayonet coupling for attachment to the lamp holder.

10. The LED retrofit lamp as claimed in claim 1, wherein the attachment ring is formed from a material comprising one or more of Polyphenylene Sulfide (PPS), Polyvinyl Toluene (PVT), Polyamide 6,6 (PA66), Polyamide 4,6 (PA46), Liquid Crystal Polymer (LCP), Polyether Ether Ketone (PEEK), Polyphthalamide (PPA), or a resin grade.

11. The LED retrofit lamp as claimed in claim 1, wherein the attachment ring is formed from a material comprising at least one of glass fibers and carbon fibers.

12. A method of assembling a light-emitting diode (LED) retrofit lamp, the method comprising:
providing a lamp body that comprises:
at least one opening,
an elastic element coupled to the lamp body at a first end, and
an LED light source coupled to the lamp body at a second end opposite the first end; providing an attachment ring that comprises:
a first wavelike axial end face, and
a second axial end face opposite the first wavelike axial end face, the first wavelike axial end face comprising a plurality of wave troughs and a plurality of wave crests, and the second axial end face abutting the elastic element;
rotating the attachment ring about the lamp body until the attachment ring is at a desired angular position relative to the lamp body; and
securing the attachment ring to the lamp body at least in part by inserting a fixing element through the opening in t e fixing element and engaging with one of the plurality of wave troughs.

13. An automotive lighting system comprising:
a vehicle headlamp comprising a lamp holder; and
an LED retrofit lamp comprising:
a lamp body having at least one opening therein,
an elastic element coupled to the lamp body at a first end,
an LED light source coupled to the lamp body at a second end opposite the first end,
an attachment ring comprising a first wavelike axial end face and a second axial end face opposite the first wavelike axial end face, the first wavelike axial end face comprising a plurality of wave troughs and a plurality of wave crests, and the second axial end face abutting the elastic element, and
at least one fixing element disposed through at least one of the at least one opening in the lamp body and at least one of the wave troughs of the first wavelike axial end face of the attachment ring, the LED retrofit lamp being attached to the lamp holder of the vehicle headlamp at least via the attachment ring.

14. The automotive lighting system as claimed in claim 13, wherein the at least one fixing element is detachably engageable with both the lamp body and the attachment ring via the at least one of the at least one opening in the lamp body and the at least one of the wave troughs of the first wavelike axial end face of the attachment ring such as to, in its engaged state, securely fix the attachment ring in one of a plurality of predetermined angular positions relative to the lamp body.

15. The automotive lighting system as claimed in claim 14, wherein the angular position of the attachment ring relative to the lamp body is fixed by the fixing element through form-locking.

16. The automotive lighting system as claimed in claim 15, wherein the angular position of the attachment ring relative to the lamp body is fixed by the fixing element through form-locking.

17. The automotive lighting system as claimed in claim 13, wherein the fixing element is a screw.

18. The automotive lighting system as claimed in claim 13, wherein the fixing element is a pin.

19. The automotive lighting system as claimed in claim 13, wherein the fixing element, when engaged with the lamp body, also engages with the one of the wave troughs of the attachment ring.

20. The automotive lighting system as claimed in claim 13, wherein the attachment ring is biased against the fixing element, when being engaged with the lamp body, by means of the elastic element.
